(19) United States
(12) Patent Application Publication
(10) Pub. No.: US 2009/0262614 A1
(43) Pub. Date: Oct. 22, 2009

(54) Demodulation of a Sampling Signal From a Storage Medium

(76) Inventor: Manfred Fechner, Villingen-Schwenningen (DE)

Correspondence Address: Thomson Licensing LLC, P.O. Box 5312, Two Independence Way, PRINCETON, NJ, 08543-5312, US

(21) Appl. No.: 11/988,395

(22) PCT Filed: Jun. 1, 2006
(86) PCT No.: PCT/EP2006/062813

§ 371 Date: Jan. 7, 2008

(30) Foreign Application Priority Data
Jul. 8, 2005 (DE) 102005032375.8

(51) Int. Cl. G11B 20/00

(52) U.S. Cl. 369/47.19; G9B/20

(57) ABSTRACT

Method for demodulating a sampling signal from a storage medium, which dispenses with the use of a PLL, and to a device for reading from and/or writing to storage media which uses such a method. Method for demodulating a sampling signal from a storage medium, the information in the sampling signal being coded in pulse lengths of an integer multiple of the period of the modulation frequency, has the steps of:

determining the current pulse length and/or the current total length of two successive pulses;

determining the maximum pulse length which occurs in the sampling signal and/or the maximum total length of two successive pulses, and

comparing at least two of the values determined in order to determine the type of sampling signal or to establish a synchronization bit sequence.

The present invention relates to a method for demodulating a sampling signal from a storage medium, in particular an optical storage medium, and to a device for reading from and/or writing to storage media which uses such a method.

In the modulated sampling signal from an optical storage medium, for example a CD (compact disc) or DVD (digital versatile disc), the information is coded in pulse lengths of an integer multiple of the period T of the modulation frequency. In code words in which one bit respectively corresponds to one period T, the end of a pulse is marked with a “1”, and times within the pulse are marked with “0”. Unambiguous synchronization bit sequences (sync pattern), which start a data frame (frame), and the absolute length of a data frame are defined. Corresponding codes are used not only in optical storage media; they can also be found, for example, in magnetic (for example magnetic tapes) or magneto-optical (for example a magneto-optical disk) storage media and in data transmission. In order to decode the sampling signal, knowledge of the following points is required:

1. Type of signal (for example CD or DVD)

2. Starting point of a data frame

3. Duration of the period T

The type of signal is generally set by the reader's firmware. The correct setting is therefore a prerequisite for the function. The period duration T is determined using a PLL (phase-locked loop) which synchronizes to the sampling signal. The quality of the PLL is thus of decisive importance. When the period duration T is known, the synchronization bit sequences can be detected and decoding may be effected.

A PLL must synchronize to the signal and thus reacts sensitively to interference in the signal. The frequency stability of the system clock can likewise no longer be achieved since, although the PLL uses the system clock as a reference, the stability of the reference cannot be achieved owing to signal interference, control fluctuation and control errors.

It is an object of the invention to propose a method for demodulating a sampling signal from a storage medium, which dispenses with the use of a PLL.

According to the invention, this object is achieved by means of a method for demodulating a sampling signal from a storage medium, the information in the sampling signal being coded in pulse lengths of an integer multiple of the period T of the modulation frequency, said method having the steps of:

determining the current pulse length and/or the current total length of two successive pulses,

determining the maximum pulse length which occurs in the sampling signal and/or the maximum total length of two successive pulses, and

comparing at least two of the values determined in order to determine the type of sampling signal or to establish a synchronization bit sequence.

The method presented here dispenses with the use of a PLL; it uses the pulse lengths measured using a fixed clock, preferably the system clock. The system clock is stable over time in the ppm range and is independent of signal interference. Negative influences as a result of fluctuations of a PLL are thus ruled out. A decision unit is preferably used to first of all convert the sampling signal into a two-stage signal. A two-stage signal simplifies measurement of the pulse lengths. In order to increase the resolution, the position of the point at which the sampling signal crosses through a reference level of the decision unit is interpolated in this case to fractions of a clock pulse. Analysing the pulse trains with respect to particular criteria then determines individual or a plurality of the following data items:

1. Type of signal

2. Synchronization time (synchronization bit sequence)

3. Period T in system clock pulses

These data enable reliable decoding of the sampling signal.

The type of sampling signal is preferably determined by comparing the maximum total length of two successive pulses with the maximum pulse length which occurs in the sampling signal. In this case, the sampling signal is assigned to a first type if the maximum total length of two successive pulses is equal to twice the maximum pulse length which occurs. This is the case, for example, if the sampling signal originates from a compact disc or a BluRay disk. In contrast, the sampling signal is assigned to a second type if the maximum total length of two successive pulses is less than twice the maximum pulse length which occurs. This is the case, for example, for the sampling signal from a digital versatile disc or a high density digital versatile disc.

Depending on the type of sampling signal, a synchronization bit sequence is established if either the current total length of two successive pulses is greater than a defined fraction of the maximum total length of two successive pulses (for the first signal type) or if the current pulse length is greater than a defined fraction of the maximum pulse length which occurs (for the second signal type).

In order to determine the period duration of the modulation frequency, the pulse lengths between two synchronization bit sequences are advantageously added to the duration of a data frame and the duration which has been determined in this manner is divided by a value that is dependent on the type of sampling signal. This makes it possible to determine the period duration of the modulation frequency without the aid of a PLL. The value that is dependent on the type of sampling signal results from the number of periods of a data frame used by the storage medium determined.

A device for reading from and/or writing to storage media, in particular optical storage media, advantageously has means for carrying out the method according to the invention.

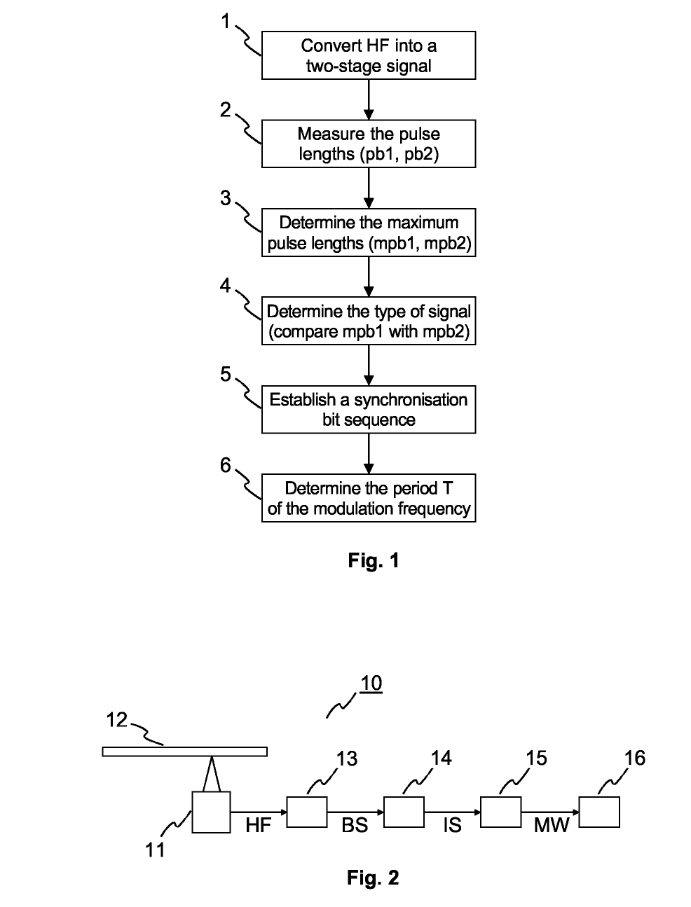

For the sake of better understanding, the invention shall be explained below with reference to FIGS. 1 and 2, in which:

FIG. 1 shows a flowchart of a method according to the invention; and

FIG. 2 shows a device for reading from and/or writing to optical storage media which uses an inventive method.

FIG. 1 shows a flowchart of a method according to the invention, as is implemented in the device 10 (diagrammatically shown in FIG. 2) for reading from and/or writing to optical storage media. The sampling signal HF which is read from an optical storage medium 12 using an optical scanner 11 is converted 1 into a two-stage signal BS with the aid of a decision unit 13 (slicer). In order to increase the resolution, the position of the point at which the signal crosses through the reference level of the decision unit 13 is interpolated to fractions of a clock pulse using an interpolator 14. A measuring unit 15 uses the interval between the last two signal crossings to determine the pulse length in clock pulses and fractions thereof, taking into account the interpolation. The sequence of measured values MW obtained in this manner is used to determine 3 the maximum pulse length (mpb1) which occurs and the maximum total length (mpb2) of two successive pulses which occurs. The maximum pulse lengths are used only in the synchronization bit sequences.

In the coding used for CDs (EFM, eight-to-fourteen modulation), the maximum pulse length which occurs is 11T (in the sync header) and the maximum length of two successive pulses is 22T for the sequence 11T/11T (likewise in the sync header). Although the pulse lengths 10T, 9T and 8T also occur in the normal data stream, the total length (pb2) of two successive pulses is considerably less than 22T in the normal data stream. Details of this are found in ECMA-130: Data interchange on read-only 120 mm optical data disks (CD-ROM).

In the coding used for DVDs (EFM+, eight-to-sixteen modulation), the maximum pulse length which occurs is 14T (in the sync code) and the maximum length of two successive pulses is 18T for the sequence 14T/4T (likewise in the sync code). Since the pulse lengths 13T, 12T and 11T do not occur in the normal data stream, the synchronization bit sequence can be readily detected using the length of 14T. For details see ECMA-337: Data Interchange on 120 mm and 80 mm Optical Disk using +RW Format—Capacity: 4.7 and 1.46 Gbytes per side.

An evaluation unit 16 now uses 4 the maximum pulse length (mpb1) which occurs and the maximum total length (mpb2) of two successive pulses to detect the signal type. If the signal is from a CD,

mpb2=2*mpb1.

If, in contrast, the signal is from a DVD,

mpb2 <2*mpb1.

This difference between the signal types is used to determine the signal type if such determination is necessary.

Depending on the signal type, the evaluation unit 16 determines 5 the starting point of a data frame by comparing the current total length (pb2) of two successive pulses with the maximum total length (mpb2) of two successive pulses or the current pulse length (pb1) with the maximum pulse length (mpb1).

In the case of a CD, the total length (pb2) of the current pulse and of the preceding pulse is determined. A synchronization bit sequence is present if

pb2 >0.9*mpb2.

In the case of a DVD, the simple length (pb1) of the current pulse is determined. A synchronization bit sequence is present if

pb1 >0.9*mbp1.

The pulse lengths between two synchronization bit sequences are integrated to form the duration TF of a data frame. The value determined in this manner is used to determine 6 the period duration T of the modulation frequency. The data frame of a CD has a length of 588T. The period duration T may thus be calculated as follows:

T=TF/588.

In contrast, the data frame of a DVD has a length of 1488T and the period duration T is thus calculated as:

T=TF/1488.

The method described can also readily be applied to other types of storage media (both optical and non-optical). For example, the maximum pulse length which occurs in the coding (17pp, RLL(1, 7) parity preserve/prohibit repeated minimum transition runlength code) used for BDs (BluRay disk) is 9T and the maximum length of two successive pulses is 18T for the sequence 9T/9T (in the synchronization bit sequence). Details of 17pp coding are disclosed in U.S. Pat. No. 6,879,637.

In contrast, in HD-DVDs (high density digital versatile disc), the maximum pulse length which occurs is 13T (in the sync code) and the maximum length of two successive pulses is 21T for the sequence 8T/13T. The pulse length 12T does not occur in the normal data stream. See US 2005/0105423 in this respect.

The maximum pulse length (mpb1) which occurs and the maximum length (mpb2) of two successive pulses may again be used to detect the signal type. If the signal is from a BD,

mpb2=2*mpb1.

If, in contrast, the signal is from a HD-DVD,

mpb2 <2*mpb1.

The data frame of a BD has a length of 1932T and the period duration T is thus:

T=TF/1932.

The following results for HD-DVDs having a data frame length of 1116T:

T=TF/1116.

A synchronization bit sequence is detected in a manner analogous to the detection in the case of CDs and DVDs. For BDs, the total length (pb2) of the current pulse and the preceding pulse is determined. A synchronization bit sequence is present in this case if

pb2 >0.9*mpb2.

In the case of a HD-DVD, the simple length (pb1) of the current pulse is determined. A synchronization bit sequence is in turn present if

pb1 >0.9*mbp1.

As when using a PLL which, as is known, locks to the clock pulses of the preceding data, the T value of the preceding data may also be used for decoding. This makes it possible to immediately decode the currently measured run lengths (rl) and obviates the need for buffer storage. If, for example, the value (determined from the preceding data) of the period duration is T=2.314 ts, ts being the period of the system clock, and the measured pulse width is pb =6.875 ts, the run length rl is calculated as:

rl=(pb/T)=2.97

=>rl=3 T.

1. Method for demodulating a sampling signal from a storage medium, the information in the sampling signal being coded in pulse lengths of an integer multiple of the period of the modulation frequency, said method having the steps of:
determining the current pulse length and/or the current total length of two successive pulses,
determining the maximum pulse length which occurs in the sampling signal and/or the maximum total length of two successive pulses, and
comparing at least two of the values determined in order to determine the type of sampling signal or to establish a synchronization bit sequence.

2. Method according to claim 1, a decision unit being used to convert the sampling signal into a two-stage signal.

3. Method according to claim 2, the position of the point at which the sampling signal crosses through a reference level of the decision unit being interpolated.

4. Method according to claim 1, the type of sampling signal being determined by comparing the maximum total length of two successive pulses with the maximum pulse length which occurs in the sampling signal.

5. Method according to claim 4, the sampling signal being assigned to a first type if the maximum total length of two successive pulses is equal to twice the maximum pulse length which occurs, and the sampling signal being assigned to a second type if the maximum total length of two successive pulses is less than twice the maximum pulse length which occurs.

6. Method according to claim 5, the sampling signal of the first type originating from a compact disc or a BluRay disk, and the sampling signal of the second type originating from a digital versatile disc or a high density digital versatile disc.

7. Method according to claim 1, a synchronization bit sequence being established if the current pulse length is greater than a defined fraction of the maximum pulse length which occurs or if the current total length of two successive pulses is greater than a defined fraction of the maximum total length of two successive pulses.

8. Method according to claim 1, said method having the further steps of:
adding the pulse lengths between two synchronization bit sequences to the duration of a data frame,
dividing the duration (TF) of a data frame by a value that is dependent on the type of sampling signal in order to determine the period duration of the modulation frequency.

9. Method according to claim 1, the pulse lengths being measured in a system clock pulse.

10. Device for reading from and/or writing to storage media, wherein it has means for carrying out the method according to claim 1.
